(19) United States
(12) Patent Application Publication
(10) Pub. No.: US 2014/0283658 A1
(43) Pub. Date: Sep. 25, 2014

(54) PROCESSING TOOL, PROCESSING DEVICE, AND PROCESSING METHOD

(71) Applicant: KABUSHIKI KAISHA TOSHIBA, MINATO-KU (JP)

(72) Inventor: Masaaki SUDO, kanagawa-ken (JP)

(73) Assignee: KABUSHIKI KAISHA TOSHIBA, MINATO-KU (JP)

(21) Appl. No.: 14/027,343

(22) Filed: Sep. 16, 2013

(30) Foreign Application Priority Data
Mar. 21, 2013 (JP) 2013-059184

(51) Int. Cl. B26D 5/00

(52) U.S. Cl. CPC B26D 5/005
USPC 83/13; 83/73

(57) ABSTRACT

According to one embodiment, a processing tool includes: a base; and a detector. The base has a region on which an object to be processed is retained on one side of the base. The detector has electrical conductivity, that includes a connecting portion provided at a periphery of the region where the object to be processed is retained, and a wiring portion connected to two ends of the connecting portion.

### CROSS-REFERENCE TO RELATED APPLICATIONS

This application is based upon and claims the benefit of priority from Japanese Patent Application No. 2013-059184, filed on Mar. 21, 2013; the entire contents of which are incorporated herein by reference.

### FIELD

Embodiments described herein relate generally to a processing tool, a processing device, and a processing method.

### BACKGROUND

Groove processing that requires high processing accuracy is sometimes performed in the mechanical processing of electronic components, precision processed components, and so on.

In groove processing for which high processing accuracy is required, it is necessary to accurately know the position of the edge of the blade.

### BRIEF DESCRIPTION OF THE DRAWINGS

FIG. 1 is a schematic view illustrating a processing tool according to a first embodiment;

FIGS. 2A and 2B are cross-sectional views at A-A in FIG. 1;

FIG. 3 is a schematic view illustrating another form of arrangement of a detector;

FIG. 4 is a schematic view illustrating another form of arrangement of an insulating layer;

FIG. 5 is a schematic view illustrating a processing tool according to a second embodiment;

FIG. 6 is a schematic view illustrating the processing device;

FIG. 7 is a schematic view illustrating a correction of a amount of movement in a Z direction of a blade; and

FIG. 8 is a schematic view illustrating causes of errors in groove processing.

### DETAILED DESCRIPTION

In general, according to one embodiment, a processing tool includes: a base; and a detector. The base has a region on which an object to be processed is retained on one side of the base. The detector has electrical conductivity, that includes a connecting portion provided at a periphery of the region where the object to be processed is retained, and a wiring portion connected to two ends of the connecting portion.

In general, according to another embodiment, a processing device includes: a processing tool including: a base having a region on which an object to be processed is retained on one side of the base; and a detector having electrical conductivity, that includes a connecting portion provided at a periphery of the region where the object to be processed is retained, and a wiring portion connected to two ends of the connecting portion; a retaining portion that retains the processing tool; a processing unit that includes a blade that processes the object to be processed that is retained on the processing tool; a control unit that controls a position of an edge of the blade in a thickness direction of the object to be processed; and a calculation unit that calculates the position of the edge of the blade in the thickness direction of the object to be processed.

In general, according to another embodiment, a processing method, includes: cutting a connecting portion provided on the processing tool described in claim 1 by controlling a position of an edge of a blade in a thickness direction of an object to be processed; finding the position of the edge of the blade based on the connecting portion that has been cut, by detecting the connecting portion that has been cut; finding an amount of movement of the blade in the thickness direction of the object to be processed when processing the object to be processed, based on the obtained position of the edge of the blade; and processing the object to be processed based on the obtained amount of movement of the blade in the thickness direction of the object to be processed.

Embodiments will now be described with reference to the drawings.

Note that the same numerals are applied to similar constituent elements in the drawings and detailed descriptions of such constituent elements are appropriately omitted. Also, in the drawings, the arrow symbols X, Y, and Z represent three mutually perpendicular directions. For example, the arrow symbols X and Y represent directions parallel to a face 2a of a base 2, and Z represents the direction perpendicular to the face 2a of the base 2.

### First Embodiment

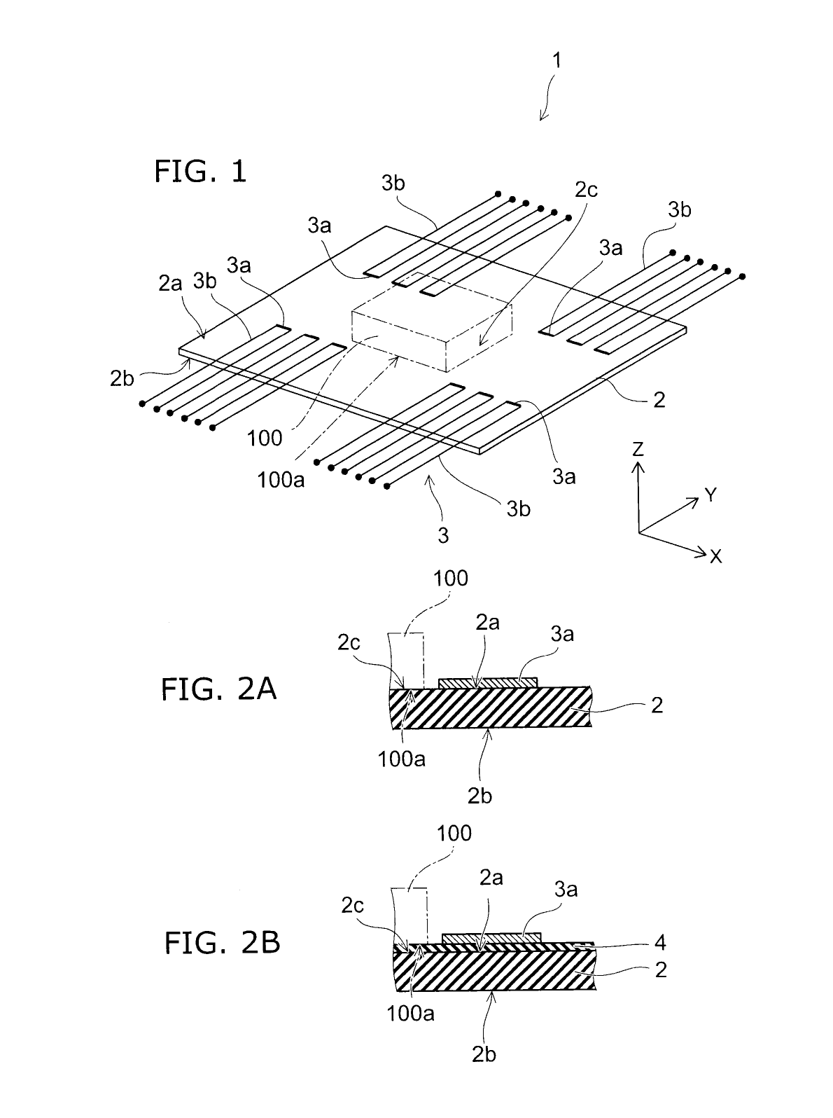

FIG. 1 is a schematic view illustrating a processing tool 1 according to a first embodiment. FIGS. 2A and 2B are cross-sectional views at A-A in FIG. 1.

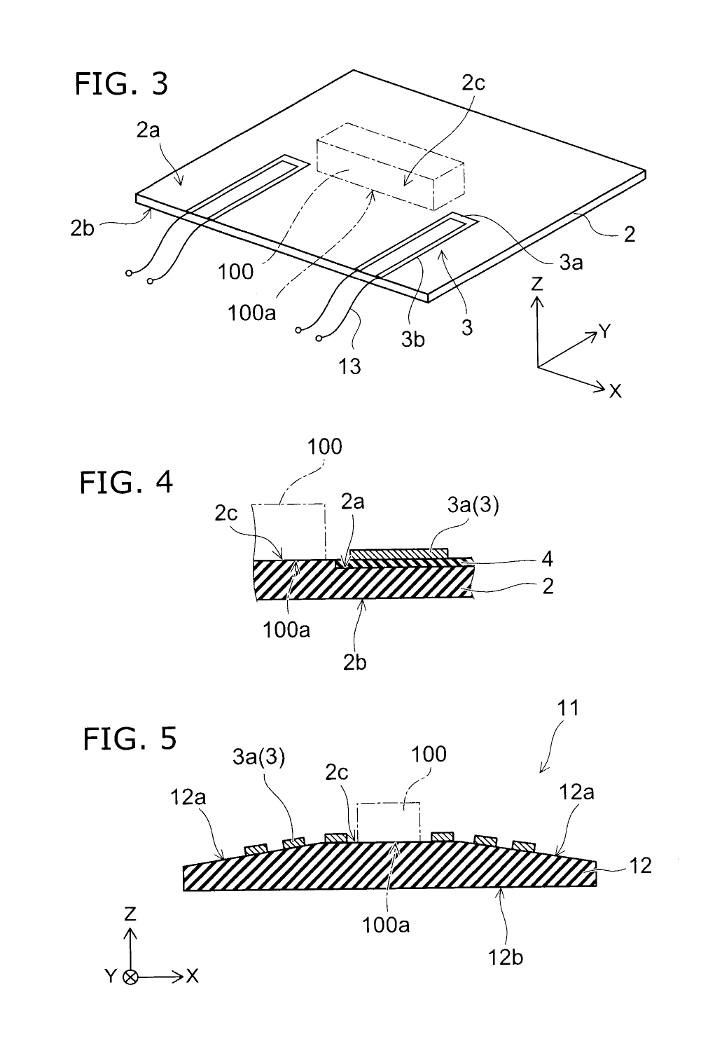

FIG. 3 is a schematic view illustrating another form of arrangement of a detector 3.

FIG. 4 is a schematic view illustrating another form of arrangement of an insulating layer 4.

As illustrated in FIG. 1, the processing tool 1 is provided with the base 2 and the detector 3.

The base 2 has a plate shape. A face 2a is provided on one side of the base 2. Also, a retaining region 2c for retaining an object to be processed is provided in the central portion of the face 2a. The face 2b on the opposite side to the retaining region 2c of the base 2 is the face on which the base 2 is retained on a retaining portion 52 of a processing device 50 that is described later.

There is no particular limitation on the external dimensions and shape of the base 2, and they can be changed as appropriate in accordance with the size and shape of a retained object to be processed 100.

Means for retaining the object to be processed 100 can be provided on the retaining region 2c of the base 2.

For example, a hole that penetrates the thickness direction (Z direction) of the base 2 can be provided in the retaining region 2c, and the object to be processed 100 is suctioned/adhered and retained using a vacuum pump or the like through the hole. In this case, a portion of the retaining region 2c of the base 2 may be formed from a porous material.

Also, an electrode can be provided on the interior of the base 2, so that the object to be processed 100 is suctioned/adhered and retained using electrostatic force.

Also, an adhesive layer can be provided on the retaining region 2c of the base 2, so that the object to be processed 100 is retained using adhesive force.

Also, the base 2 can be formed from a translucent material such as glass or the like, and the object to be processed 100 may be fixed to the retaining region 2c of the base 2 with an adhesive that can be easily peeled off by irradiating with ultraviolet light.

The means for retaining the object to be processed 100 is not limited to these examples, but can be changed as appropriate.

If the insulating layer 4 is not provided between the detector 3 and the base 2 as illustrated in FIG. 2A, the base 2 is formed from an insulating material. In this case, preferably a material with high dimensional stability is used. Examples of insulating materials with high dimensional stability include glass, ceramics, and so on.

If the insulating layer 4 is provided between the detector 3 and the base 2 as illustrated in FIG. 2B, there is no particular limitation on the material of the base 2. However, preferably a material with high dimensional stability is used. Examples of materials with high dimensional stability include metals, glass, ceramics, and so on.

The detector 3 detects the position in the Z direction (the thickness direction of the object to be processed 100) of an edge of a blade (rotating blade) 53b that is described later.

The detector 3 includes a connecting portion 3a provided around the retaining region 2c, and two wiring portions 3b connected to the two ends of the connecting portion 3a.

Preferably the face of the connecting portion 3a on the base 2 side and the installation face 100a of the object to be processed 100 are substantially coplanar.

In this specification, substantially coplanar means a difference of about ±0.5 μm is permitted.

The ends of the wiring portions 3b on the opposite side to the side connected to the connecting portion 3a project to the outside from the periphery of the base 2. As illustrated in FIG. 3, the ends of the wiring portions 3b on the opposite side to the sides connected to the connecting portion 3a may be provided near the periphery of the base 2, and electric wiring 13 or the like may be connected to the ends provided near the periphery of the base 2.

There is no particular limitation on the material of the connecting portion 3a and the wiring portions 3b provided they are electrically conducting materials. The material of the connecting portion 3a and the wiring portions 3b can be, for example, metal or the like.

There is no particular limitation on the method of forming the connecting portion 3a and the wiring portions 3b. The connecting portion 3a and the wiring portions 3b can be formed integrally using, for example, the screen printing method or a plating method and so on.

At least one detector 3 is provided.

If a plurality of detectors is provided, the detection accuracy and therefore the processing accuracy can be improved.

Improving the detection accuracy is discussed in detail later.

If a plurality of detectors 3 is provided, a plurality of connecting portions 3a can be provided sandwiching the retaining region 2c.

In the case of an object to be processed 100 having a plan shape with long dimensions in the X direction and the Y direction (for example, a rectangular shape), as illustrated in FIG. 1, at least one connecting portion 3a can be provided near each of the four corners of the object to be processed 100. In other words, the plurality of connecting portions 3a can be provided beside the four corners of the object to be processed 100 sandwiching the retaining region 2c.

In this way, it is possible to detect the position in the Z direction of the edge of a blade 53b including the errors in flatness and parallelism of the retaining portion 52 of the processing device 50 that is described later.

In the case of an object to be processed 100 having a plan shape with long dimensions in the X direction or the Y direction (for example, a rectangular shape), as illustrated in FIG. 3, at least one connecting portion 3a can be provided near each of the two ends in the length direction of the object to be processed 100. In other words, the plurality of connecting portions 3a can be provided sandwiching the retaining region 2c in the length direction of the object to be processed 100.

In this way, it is possible to detect the position in the Z direction of the edge of a blade 53b including the errors in flatness of the retaining portion 52 of the processing device 50 that is described later.

The form of arrangement and the number of detectors 3 is not limited to these examples, but can be changed as appropriate in accordance with the shape and external dimensions of the object to be processed 100, the required detection accuracy, and so on.

The insulating layer 4 can be provided at least between the connecting portion 3a and the base 2, as illustrated in FIG. 2B.

As stated previously, preferably the face of the connecting portion 3a on the base 2 side and the installation face 100a of the object to be processed 100 are substantially coplanar.

Therefore, the insulating layer 4 can be provided on the region of the face 2a of the base 2 where the connecting portion 3a is provided and on the retaining region 2c of the base 2. In this case, a hole can be provided in the insulating layer 4 provided on the retaining region 2c of the base 2 for suctioning/adhering and retaining the object to be processed 100.

Also, as illustrated in FIG. 4, if the retaining region 2c of the base 2 projects from the face 2a, the top face of the insulating layer 4 and the retaining region 2c of the base 2 may be substantially coplanar.

There is no particular limitation on the material of the insulating layer 4 provided it is an insulating material.

If the insulating layer 4 is provided, it is possible to increase the degree of freedom in the selection of the material of the base 2.

Also, as described later, when detecting the position in the Z direction of the edge of the blade 53b, the connecting portion 3a is cut. Therefore, if the insulating layer 4 is provided, it is possible to reduce the damage to the base 2.

Also, by peeling the cut connecting portion 3a, the wiring portions 3b, and the insulating layer 4 from the face 2a of the base 2, and reforming the insulating layer 4, the connecting portion 3a, and the wiring portions 3b on the face 2a of the base 2, the processing tool 1 can be easily regenerated.

### Second Embodiment

FIG. 5 is a schematic view illustrating a processing tool 11 according to a second embodiment. As illustrated in FIG. 5, the processing tool 11 is provided with a base 12 and detectors 3.

The base 12 has a plate shape. The retaining region 2c for retaining an object to be processed is provided on one side of the base 12. The retaining region 2c is provided in the central portion of the base 12, and slanting faces 12a are provided around the periphery of the retaining region 2c. The face 12b on the opposite side to the retaining region 2c of the base 12 is the face on which the base 12 is retained on the retaining portion 52 of the processing device 50 that is described later.

On the slanting faces 12a, the sides at the periphery of the base 12 are closer to the face 12b than the sides at the center of the base 12.

In other words, the slanting faces 12a are slanting in the direction such that the thickness dimension of the base 12 becomes shorter the closer to the periphery of the base 12.

The connecting portion 3a of the detector 3 is provided on the slanting faces 12a.

If a plurality of connecting portions 3a is provided on the slanting faces 12a, the positions in the Z direction of the faces of the connecting portions 3a on the base 12 side can be different.

Here, it is easy to form the slanting faces 12a having high dimensional accuracy. Therefore, it is possible to change slightly the positions in the Z direction of the faces of the connecting portions 3a on the side of the base 12. For example, if the slanting faces are formed at an angle of 1°, for a difference of 1 mm in the Y direction in the position of the slanting faces, a displacement in the Z direction of 0.017 mm is produced. In this way, it is possible to finely determine the position in the Z direction on the slanting faces 12a, and in addition, it is possible to increase the resolution of the detection position. Therefore, it is possible to increase the detection accuracy, as discussed later.

There is no particular limitation on the external dimensions and shape of the base 12, and they can be changed as appropriate in accordance with the size and shape of the retained object to be processed 100.

Means for retaining the object to be processed 100 can be provided on the retaining region 2c of the base 12.

For example, a hole that penetrates the thickness direction (Z direction) of the base 12 can be provided in the retaining region 2c, and the object to be processed 100 can be suctioned/adhered and retained using a vacuum pump or the like through the hole. In this case, a portion of the retaining region 2c of the base 12 may be formed from a porous material.

Also, an electrode can be provided on the interior of the base 12, so that the object to be processed 100 is suctioned/adhered and retained using electrostatic force.

Also, an adhesive layer can be provided on the retaining region 2c of the base 12, so that the object to be processed 100 is retained using adhesive force.

The means for retaining the object to be processed 100 is not limited to these examples, but can be changed as appropriate.

Also, the material of the base 12 can be the same as the material of the base 2 as described above. Also, the insulating layer 4 can be provided, similar to the processing tool 1 as described above.

### Third Embodiment

Next, the processing device 50 according to a third embodiment is described.

A case in which the processing tool 1 is retained is illustrated as an example, but processing tools with a different form (for example, the processing tool 11) can be retained.

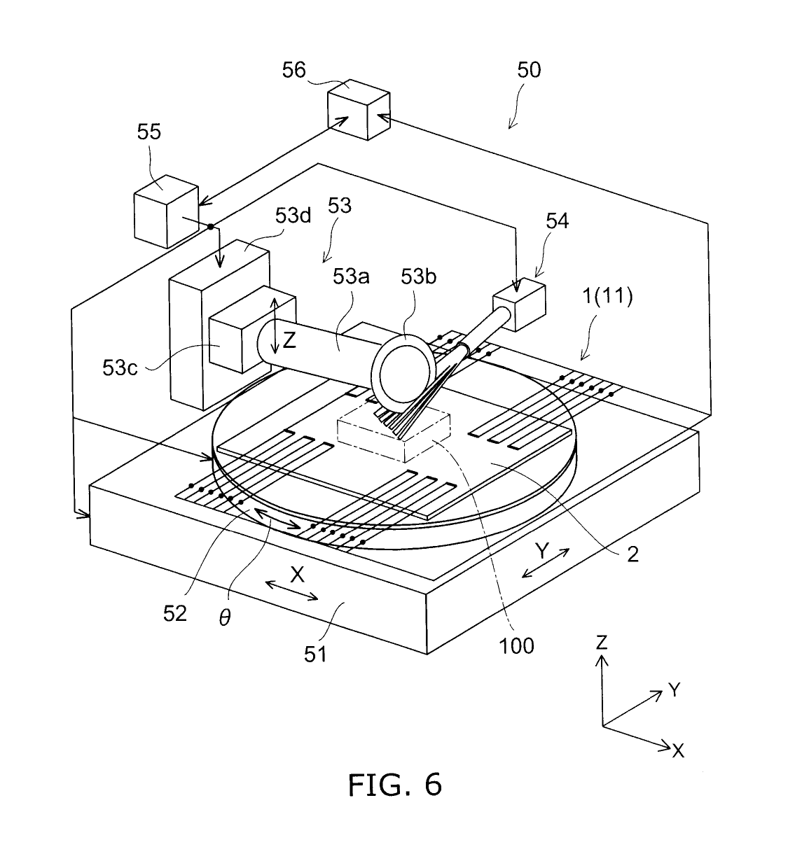

FIG. 6 is a schematic view illustrating the processing device 50.

As illustrated in FIG. 6, the processing device 50 is provided with a pedestal 51, a retaining portion 52, a processing unit 53, a cutting fluid supply unit 54, a control unit 55, and a calculation unit 56.

Also, a measurement device that is not illustrated on the drawings that measures the position of the top face of the object to be processed 100 that is retained on the processing tool 1 can be further provided.

The pedestal 51 can be, for example, an XY table or the like.

The retaining portion 52 is provided on the top face of the pedestal 51. The retaining portion 52 retains the processing tool 1.

The retaining portion 52 is provided with retaining means which is not illustrated on the drawings for retaining the processing tool 1. The retaining means which is not illustrated on the drawings can be, for example, a device using vacuum force or electrostatic force.

The retaining portion 52 is driven to rotate in the θ direction by a drive unit that is not illustrated on the drawings.

The processing unit 53 is provided with a spindle 53a, the blade 53b, a rotational drive unit 53c, and an elevating and lowering unit 53d.

The spindle 53a has a rotating shaft. The blade 53b is installed on one end of the rotating shaft of the spindle 53a. The rotational drive unit 53c is provided on the other end of the rotating shaft of the spindle 53a.

The blade 53b processes the object to be processed 100 that is retained on the processing tool 1. The blade 53b can include, for example, diamond abrasive grains.

The rotational drive unit 53c rotates the blade 53b by rotating the rotating shaft of the spindle 53a. The rotational speed of the rotating shaft of the spindle 53a is adjusted as appropriate in accordance with the diameter of the blade 53b and material of the object to be processed 100, and so on.

The elevating and lowering unit 53d changes the position in the Z direction of the edge of the blade 53b, by raising or lowering the rotational drive unit 53c.

Drive units in the X direction, Y direction, Z direction, and θ direction are not limited to those as described above. For example, drive units in the X direction, Y direction, and Z direction can be provided on the pedestal 51.

The cutting fluid supply unit 54 supplies cutting fluid to the portion to be processed when processing the object to be processed 100. The cutting fluid can be, for example, a water-soluble coolant or the like.

The control unit 55 controls the operation of each of the elements provided in the processing device 50. For example, the control unit 55 controls the drive units provided in the pedestal 51, the retaining portion 52, and the processing unit 53, to control the position of the edge of the blade 53b. The control unit 55 also controls the drive unit provided in the processing unit 53 to rotate or stop the blade 53b, and controls the cutting fluid supply unit 54 to supply or stop the cutting fluid.

The calculation unit 56 is electrically connected to the detector 3. If a plurality of detectors 3 is provided, the plurality of detectors 3 is connected to the calculation unit 56 in parallel.

Here, by detecting at least one of the electrical resistance of the detector 3 (connecting portion 3a), the current flowing in the detector 3 (connecting portion 3a), and the voltage in the detector 3 (connecting portion 3a), it is possible to detect that the connecting portion 3a has been cut.

Therefore, by cutting the connecting portion 3a with the blade 53b, and detecting that the connecting portion 3a has been cut, it is possible to detect the position in the Z direction of the edge of the blade 53b.

Also, if the face of the connecting portion 3a on the side of the base 2 and the installation face 100a of the object to be processed 100 are substantially coplanar, it is also possible to detect the position in the Z direction of the installation face 100a of the object to be processed 100.

The calculation unit 56 calculates the position in the Z direction of the edge of the blade 53b based on information on the position in the Z direction of the blade 53b supplied from the control unit 55 and information from the detector 3 that the connecting portion 3a has been cut. Also, the calculation unit 56 can calculate the position in the Z direction of the installation face 100a of the object to be processed 100.

Also, the calculation unit 56 calculates the amount of movement (the amount of processing) in the Z direction of the blade 53b based on the depth dimension of the groove to be processed that is set in advance, the thickness dimension of the object to be processed 100 that is measured in advance, information on the position in the Z direction of the edge of the blade 53b, and information on the position in the Z direction of the installation face 100a of the object to be processed 100.

When the position of the top face of the object to be processed 100 that is retained on the processing tool 1 is measured, the calculation unit 56 calculates the amount of movement in the Z direction of the blade 53b based on the depth dimension of the groove to be processed that is determined in advance, information on the position of the top face of the object to be processed 100, and information on the position in the Z direction of the edge of the blade 53b.

Information regarding the calculated amount of movement in the Z direction of the blade 53b is sent to the control unit 55, and the object to be processed 100 is processed.

Also, if a plurality of detectors 3 is provided, it is possible to increase the detection accuracy and therefore the processing accuracy.

For example, by detecting the position in the Z direction of a plurality of connecting portions 3a that have been cut, it is possible to detect the variation in the position in the Z direction on the processing tool 1. Therefore it is possible to correct the amount of movement in the Z direction of the blade 53b based on the variation in the position in the Z direction that has been detected.

In this way, it is possible to improve the detection accuracy, and therefore it is possible to improve the processing accuracy.

Also, as illustrated in FIG. 3, if at least one connecting portion 3a is provided near each of the two ends in the length direction of the object to be processed 100, it is possible to detect variation in the position in the Z direction in the length direction of the object to be processed 100, in other words, it is possible to detect slanting of the positioned object to be processed 100. Therefore it is possible to correct the amount of movement in the Z direction of the blade 53b based on the variation in the position in the Z direction that has been detected.

In this way, it is possible to further improve the detection accuracy, and therefore it is possible to further improve the processing accuracy.

Also, as illustrated in FIG. 1, if at least one connecting portion 3a is provided near each of the four corners of the object to be processed 100, it is possible to detect in-plane variation in the position in the Z direction, in other words, it is possible to further precisely detect slanting of the positioned object to be processed 100. Therefore it is possible to correct the amount of movement in the Z direction of the blade 53b based on the variation in the position in the Z direction that has been detected.

In this way, it is possible to further improve the detection accuracy, and therefore it is possible to further improve the processing accuracy.

Also, as illustrated in FIG. 5, if the connecting portions 3a are provided on slanting faces 12a of the base 12, it is possible to gradually slightly change the position in the Z direction of the connecting portions 3a along the slanting faces 12a. For example, if the slanting faces are formed at an angle of 1°, for a difference of 1 mm in the Y direction in the position of the slanting faces, a displacement in the Z direction of 0.017 mm is produced.

Therefore, it is possible to more precisely detect the position in the Z direction of the connecting portions 3a that have been cut, so it is possible to further improve the detection accuracy. As a result, it is possible to further improve the processing accuracy.

Next, the action of the processing device 50 and the processing method are described.

First, the processing tool 1 on which the object to be processed 100 is retained in the retaining region 2c is retained on the retaining portion 52.

Next, the position in the Z direction of the edge of the blade 53b is detected.

For example, the connecting portion 3a is cut by the blade 53b by controlling the elevating and lowering unit 53d with the control unit 55. In other words, the control unit 55 controls the position of the edge of the blade 53b to cut the connecting portion 3a provided on the processing tool 1.

When the connecting portion 3a is cut, the electrical resistance and so on of the detector 3 is changed. Therefore, the position in the Z direction of the edge of the blade 53b can be detected by the calculation unit 56 based on information on the position from the control unit 55, and the change in the electrical resistance and so on of the detector 3. In other words, the calculation unit 56 detects that the connecting portion 3a has been cut, and calculates the position of the edge of the blade 53b based on the connecting portion 3a that has been cut. Also, it is possible to detect the position in the Z direction of the installation face 100a of the object to be processed 100.

When the connecting portion 3a is cut, cutting fluid is supplied from the cutting fluid supply unit 54. Therefore, when detecting the electrical resistance or the like of the detector 3, air is blown across the detector 3 from an air blowing device that is not shown on the drawings, to remove the cutting fluid.

Also, the calculation unit 56 calculates the amount of movement in the Z direction of the blade 53b based on the depth dimension of the groove to be processed that is set in advance, the thickness dimension of the object to be processed 100 that is measured in advance, information on the position in the Z direction of the edge of the blade 53b, and information on the position in the Z direction of the installation face 100a of the object to be processed 100.

The position of the top face of the object to be processed 100 that is retained on the processing tool 1 can be measured using a measuring device that is not shown on the drawings. When the position of the top face of the object to be processed 100 is measured, the calculation unit 56 calculates the amount of movement in the Z direction of the blade 53b based on the depth dimension of the groove to be processed that is determined in advance, information on the position of the top face of the object be processed 100, and information on the position in the Z direction of the edge of the blade 53b.

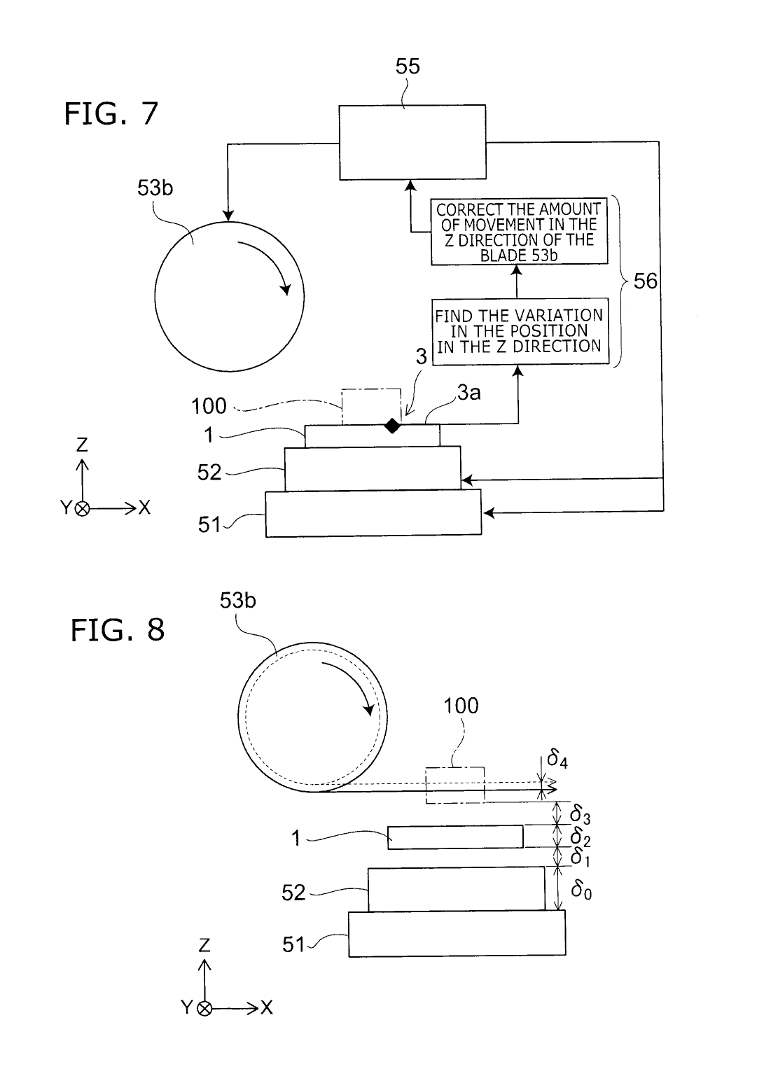

Next, the calculation unit 56 can correct the amount of movement in the Z direction of the blade 53b. FIG. 7 is a schematic view illustrating the correction of the amount of movement in the Z direction of the blade 53b. As illustrated in FIG. 7, the calculation unit 56 calculates the variation in the position in the Z direction, and corrects the amount of movement in the Z direction of the blade 53b based on the variation in the position in the Z direction.

For example, if a plurality of detectors 3 is provided, the calculation unit 56 calculates the variation in the position in the Z direction on the processing tool 1 by detecting the positions in the Z direction of the plurality of connecting portions 3a that have been cut. Then, based on the variation in the position in the Z direction that has been obtained, the calculation unit 56 corrects the amount of movement in the Z direction of the blade 53b.

Also, if at least one connecting portion 3a is provided near each of the two ends in the length direction of the object to be processed 100, the calculation unit 56 calculates the variation in the position in the Z direction in the length direction of the object to be processed 100, in other words, calculates the slant in the positioned object to be processed 100, by detecting the positions in the Z direction of the connecting portions 3a at both ends of the object to be processed 100. Then, based on the variation in the position in the Z direction that has been obtained, the calculation unit 56 corrects the amount of movement in the Z direction of the blade 53b.

Also, if at least one connecting portion 3a is provided near each of the four corners of the object to be processed 100, the calculation unit 56 calculates the variation in-plane of the positions in the Z direction of the object to be processed 100, in other words, calculates the slant of the positioned object to be processed 100, by detecting the positions in the Z direction of the cut connecting portions 3a at the four corners of the object to be processed 100. Then, based on the variation in the position in the Z direction that has been obtained, the calculation unit 56 corrects the amount of movement in the Z direction of the blade 53b.

Information regarding the corrected amount of movement in the Z direction of the blade 53b is sent to the control unit 55, and the object to be processed 100 is processed.

Movement of the pedestal 51, the retaining portion 52, and the processing unit 53 in the X direction, Y direction, Z direction, and θ direction, rotation of the blade 53b, supply of the cutting fluid, and so on can be carried out using the action of known technologies, so their detailed explanation is omitted.

As explained above, the processing method according to this embodiment can include the following processes:

A process of cutting the connecting portions 3a provided on the processing tool 1, 11 by controlling the position of the edge of the blade 53b in the thickness direction (Z direction) of the object to be processed 100.

A process of detecting that the connecting portion 3a has been cut, and finding the position of the edge of the blade 53b based on the cut connecting portion 3a.

A process of finding the amount of movement of the blade 53b in the thickness direction of the object to be processed 100 when processing the object to be processed 100, based on the obtained position of the edge of the blade 53b. A process of processing the object to be processed 100 based on the obtained amount of movement of the blade 53b in the thickness direction of the object to be processed 100.

In addition, a process of correcting the amount of movement of the blade 53b in the thickness direction of the object to be processed 100, and so on can be included.

The content of each process is the same as that described above, so their detailed explanation is omitted.

FIG. 8 is a schematic view illustrating the causes of errors in groove processing.

In FIG. 8, δ0 is the error in the shape of the retaining portion 52, δ1 is the error in the gap between the processing tool 1 and the retaining portion 52, δ2 is the error in the shape of the processing tool 1, δ3 is the error in the gap between the processing tool 1 and the object to be processed 100, and δ4 is the error due to wear of the blade 53b.

The overall error in groove processing can be obtained from the sum of δ0 to δ4 (=δ0+δ1+δ2+δ3+δ4).

Therefore, the overall error in the groove processing can be minimized by the processing tool, the processing device, and the processing methods according to the embodiment.

Also, with the processing tool, the processing device, and the processing method according to the embodiment, it is possible to accurately detect the position of the edge of the blade 53b, and also to correct the amount of movement in the Z direction of the blade 53b.

Therefore, it is possible to improve the processing accuracy of groove processing even when, for example, the groove width dimension is about 0.10 mm and the groove shape is easily distorted.

Also, the processing tool according to the embodiment can be used in existing processing devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A processing tool comprising:
a base having a region on which an object to be processed is retained on one side of the base; and
a detector having electrical conductivity, that includes a connecting portion provided at a periphery of the region where the object to be processed is retained, and a wiring portion connected to two ends of the connecting portion.

2. The processing tool according to claim 1 provided with a plurality of the detectors.

3. The processing tool according to claim 1, wherein a plurality of the connecting portions is provided sandwiching the region that retains the object to be processed.

4. The processing tool according to claim 1, further comprising a slanting face at the periphery of the region that retains the object to be processed, wherein
the connecting portion is provided on the slanting face.

5. The processing tool according to claim 4, wherein the slanting face slants in a direction so that the thickness dimension of the base lessens towards a peripheral edge of the base.

6. The processing tool according to claim 4, wherein a plurality of the detectors is provided on the slanting face.

7. The processing tool according to claim 1, wherein a plurality of the connecting portions is provided sandwiching the region that retains the object to be processed in a length direction of the object to be processed.

8. The processing tool according to claim 1, wherein at least one of the connecting portion is provided near each of two ends in the length direction of the region that retains the object to be processed.

9. The processing tool according to claim 1, wherein a plurality of the connecting portions is provided sandwiching the region that retains the object to be processed, beside the four corners of the object to be processed.

10. The processing tool according to claim 1, wherein at least one of the connecting portion is provided near each of the four corners of the region that retains the object to be processed.

11. The processing tool according to claim 1, further comprising an insulating layer provided between the connecting portion and the base.

12. The processing tool according to claim 11, wherein the base is formed from at least one material selected from the group consisting of metal, glass, and ceramics.

13. The processing tool according to claim 1, wherein the base is formed from an insulating material with high dimensional stability.

14. The processing tool according to claim 13, wherein the base is formed from at least one of glass and ceramics.

15. A processing device comprising:
a processing tool including:
a base having a region on which an object to be processed is retained on one side of the base; and
a detector having electrical conductivity, that includes a connecting portion provided at a periphery of the region where the object to be processed is retained, and a wiring portion connected to two ends of the connecting portion;
a retaining portion that retains the processing tool;
a processing unit that includes a blade that processes the object to be processed that is retained on the processing tool;
a control unit that controls a position of an edge of the blade in a thickness direction of the object to be processed; and
a calculation unit that calculates the position of the edge of the blade in the thickness direction of the object to be processed.

16. The device according to claim 15, wherein:
the control unit controls the position of the edge of the blade to cut the connecting portion provided on the processing tool, and
the calculation unit detects that the connecting portion has been cut, and calculates the position of the edge of the blade based on the connecting portion that has been cut.

17. The device according to claim 16, wherein the calculation unit is electrically connected to the connecting portion.

18. The device according to claim 17, wherein the calculation unit detects that the connecting portion is cut by detecting at least one of the electrical resistance of the connecting portion, the current flowing in the connecting portion, and the voltage in the connecting portion.

19. A processing method, comprising:
cutting a connecting portion provided on the processing tool described in claim 1 by controlling a position of an edge of a blade in a thickness direction of an object to be processed;
finding the position of the edge of the blade based on the connecting portion that has been cut, by detecting the connecting portion that has been cut;
finding an amount of movement of the blade in the thickness direction of the object to be processed when processing the object to be processed, based on the obtained position of the edge of the blade; and
processing the object to be processed based on the obtained amount of movement of the blade in the thickness direction of the object to be processed.

20. The method according to claim 19, wherein:
a plurality of the connecting portions is cut in the process of cutting the connecting portion;
in the process of finding the position of the edge of the blade, the positions of the plurality of the connecting portions that have been cut are detected, and variation in the positions on the processing tool is obtained; and
in the process of finding the amount of movement of the blades, the amount of movement of the blade is corrected based on the variation in the positions obtained.
